(19) United States
(12) Patent Application Publication
(10) Pub. No.: US 2024/0330671 A1
(43) Pub. Date: Oct. 3, 2024

(54) AUTOMATION METHOD FOR DEFECT CHARACTERIZATION FOR HYBRID BONDING APPLICATION

(71) Applicant: Applied Materials, Inc., Santa Clara, CA (US)

(72) Inventors: Rahul Reddy KOMATIREDDI, Bangalore (IN); Rohith CHERIKKALLIL, Bangalore (IN); Sneha Rupa KONGARA, Bangalore (IN); Sachin DANGAYACH, San Jose, CA (US); Prayudi LIANTO, Singapore (SG); Peng SUO, Singapore (SG); Krishnaprasad Reddy MALLAVARAM, Bangalore (IN); Satwik Swarup MISHRA, Bengaluru (IN); Si En CHAN, Singapore (SG); Remus Zhen Hui KOH, Singapore (SG); Khor Wui CHENG, Singapore (SG); Yin Wei LIM, Singapore (SG)

(21) Appl. No.: 18/128,496

(22) Filed: Mar. 30, 2023

(51) Int. Cl. G06N 3/08

(52) U.S. Cl. CPC G06N 3/08

(57) ABSTRACT

A method and apparatus for training a learning model for the automatic detection and classification of defects on wafers includes receiving labeled images of wafer defects having multiple defect classifications, creating a first training set including the received labeled images of wafer defects, training the machine learning model to automatically detect and classify wafer defects in a first stage using the first training set, blending at least one set of at least two labeled images having different classifications to generate additional labeled image data, creating a second training set including the blended, additional labeled image data, and training the machine learning model to automatically detect and classify wafer defects in a second stage using the second training set. The trained machine learning model can then be applied to at least one unlabeled wafer image to determine at least one defect classification for the at least one unlabeled wafer image.

### FIELD

Embodiments of the present principles generally relate to detecting defects in wafers and in particular to the automatic detection and classification of defects on wafers.

### BACKGROUND

Wafer defects can be caused by processes in which wafers are manipulated. There currently exists many manual processes for detecting and classifying such defects. For example, Hybrid Bonding for wafers in, for example, semiconductor wafer metrology, packaging processes, plasma processes, wet clean or wafer singulation processes currently requires implementing various metrology and imaging tools which help to manually identify failures existing on the wafers, in some examples, between process steps. Current state of the art failure analysis approaches include a combination of optical inspection tools and scanning tools, such as scanning electron microscopy (SEM) and automated optical inspection (AOI) review tools, in which defect locations on wafers are first identified using an inspection tool and then are inspected using an SEM review tool for further defect characterization. Such approaches are based on manual characterization of huge amounts of data.

That is, in all current failure analysis approaches, a manual effort is required to inspect images and categorize the defects into various categories. For example, currently, optical inspection tools can be used to capture the defects from sample images and the images are labelled into various defect categories for further review and analysis using manual approaches. In such current failure analysis processes, the manual defect review and classification is time consuming. For example, the manual review and classification process can take 5˜30 mins for each wafer depending on the amount of defects on the wafer. Even further, manual review can lead to inaccuracy due to human judgement

What is needed is a process to automate the detection and classification of defects, for example, during the various processes involved in the Hybrid Bonding of wafers, that is accurate and efficient.

### SUMMARY

Methods and apparatus for the automatic detection of defects on wafers and the automatic classification of the defects on the wafers, for example, during the various processes involved in Hybrid Bonding are provided herein.

In some embodiments a method for training a machine learning model for the automatic detection and classification of defects on wafers includes receiving labeled images of wafer defects having multiple defect classifications, creating a first training set comprising the received labeled images of wafer defects having the multiple defect classifications, training the machine learning model to automatically detect and classify wafer defects in a first stage using the first training set, blending at least one set of at least two labeled images having different classifications to generate additional labeled image data, creating a second training set comprising the generated blended, additional labeled image data, and training the machine learning model to automatically detect and classify wafer defects in a second stage using the second training set.

In some embodiments the method further includes blending the at least one set of the at least two labeled images having different classifications using at least one weighted component.

In some embodiments a method for the automatic detection and classification of defects on wafers using a trained machine learning model includes receiving at least one unlabeled image of a surface of a wafer, applying the trained machine learning (ML) model to the at least one unlabeled wafer image, the machine learning model having been trained to detect and classify defects on wafers using a first set of labeled images of wafer defects and a second set of additional wafer defect images generated from at least two labeled images having different classifications being blended, and determining at least one defect classification for the at least one unlabeled wafer image using the trained machine learning model. In some embodiments, the trained ML model comprises at least one of a vision transformer model, a convolutional neural network model, or a recurrent neural network model.

In some embodiments, the method further includes determining if the wafer contains a critical defect from the at least one determined defect classification.

In some embodiments, an apparatus for training a machine learning model for the automatic detection and classification of defects on wafers includes a processor and a memory. In some embodiments, the memory has stored therein at least one program, the at least one program including instructions which, when executed by the processor, cause the apparatus to perform a method including receiving labeled images of wafer defects having multiple defect classifications, creating a first training set comprising the received labeled images of wafer defects having the multiple defect classifications, training the machine learning model to automatically detect and classify wafer defects in a first stage using the first training set, blending at least one set of at least two labeled images having different classifications to generate additional labeled image data, creating a second training set comprising the generated blended, additional labeled image data, and training the machine learning model to automatically detect and classify wafer defects in a second stage using the second training set.

In some embodiments, the method of the apparatus is further configured to blend the at least one set of the at least two labeled images having different classifications using at least one weighted component.

In some embodiments, an apparatus for the automatic detection and classification of defects on wafers using a trained machine learning model includes a processor, and a memory. In some embodiments the memory has stored therein at least one program, the at least one program including instructions which, when executed by the processor, cause the apparatus to perform a method including receiving at least one unlabeled image of a surface of a wafer, applying the trained machine learning (ML) model to the at least one unlabeled wafer image, the machine learning model having been trained to detect and classify defects on wafers using a first set of labeled images of wafer defects and a second set of additional wafer defect images generated from at least two labeled images having different classifications being blended, and determining at least one defect classification for the at least one unlabeled wafer image using the trained machine learning model.

In some embodiments the method of the apparatus is further configured to determine if the wafer contains a critical defect from the at least one determined defect classification.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 depicts a high-level block diagram of a wafer defect detection and classification system in accordance with an embodiment of the present principles.

FIG. 2 depicts a graphical representation of a mix-up augmentation that can be implemented by the training and data generation module for generating training data for training the Deep Learning model in accordance with an embodiment of the present principles.

FIG. 3A depicts an image of a stain defect on a wafer and a corresponding attention map image of a region of focus of a machine learning model/algorithm of the present principles when processing the image.

FIG. 3B depicts an image of a particle defect on a wafer and a corresponding attention map image of a region of focus of a learning model/algorithm of the present principles when processing the image.

FIG. 3C depicts an image of a fiber defect on a wafer and a corresponding attention map image of a region of focus of a learning model/algorithm of the present principles when processing the image.

FIG. 3D depicts an image of a wafer having no defect and a corresponding attention map image of a region of focus of a machine learning model/algorithm of the present principles when processing the image.

FIG. 4 depicts a graphical representation of a functional training architecture of a wafer defect detection and classification system of the present principles in accordance with an embodiment.

FIG. 5 depicts a graphical representation of a functional architecture of a wafer defect detection and classification system of the present principles in accordance with an embodiment.

FIG. 6 depicts a flow diagram of a method for training a machine learning model for the automatic detection and classification of defects on wafers in accordance with an embodiment of the present principles.

FIG. 7 depicts a flow diagram of a method for the automatic detection and classification of defects on wafers in accordance with an embodiment of the present principles.

FIG. 8 depicts a high-level block diagram of a computing device suitable for use with embodiments of a wafer defect detection and classification system in accordance with the present principles.

FIG. 9 depicts a high-level block diagram of a network in which embodiments of a wafer defect detection and classification system of the present principles can be applied in accordance with an embodiment.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The following detailed description describes techniques (e.g., methods, apparatuses, and systems) for the automatic detection of defects on wafers and the automatic classification of the defects on the wafers, for example, during the various processes involved in Hybrid Bonding. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described herein with respect to specific wafer defects and classification categories related to defects that can occur during a hybrid bonding process, embodiments of the present principles can be applied to automatically detect and classify substantially any wafer defects that occur during any processes involving wafers into substantially any classification categories.

Throughout this disclosure the terms learning model, machine learning (ML) model, ML algorithm, and ML classifier are used interchangeably to describe an ML process that can be trained to recognize/detect and distinguish between various types of defects that occur on wafers and to classify the defects into categories.

Embodiments of the present principles enable the automatic detection of wafer defects and the automatic classification of defects into respective categories with consistency, repeatability and efficiency. That is, embodiments of the present principles provide the ability to automate the detection and classification of defects on wafers, for example, during the various processes involved in Hybrid Bonding like plasma, wet clean, and/or wafer singulation. In embodiments of the present principles, a learning model, via a novel training process, is trained to be able to detect/recognize defects on wafers and to distinguish between various types of defects that occur on wafers and classify the defects into categories. In some embodiments, the defects can be classified into categories including, but not limited to, particle defect, fiber defect, stain defect and/or no defect.

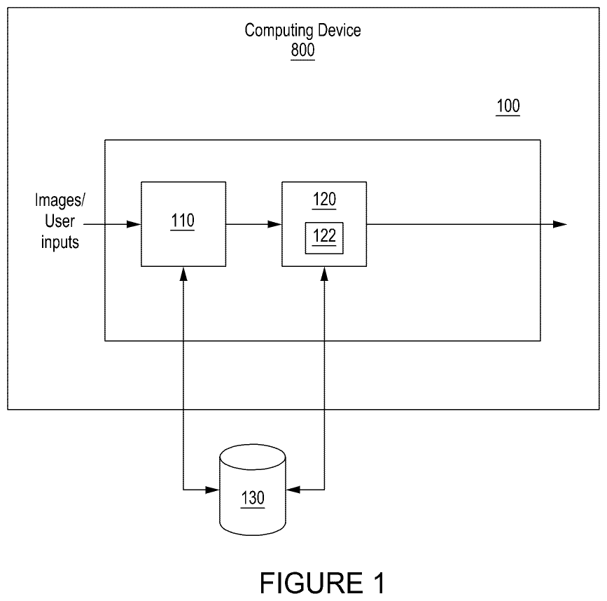

FIG. 1 depicts a high-level block diagram of a wafer defect detection and classification system 100 in accordance with an embodiment of the present principles. In the embodiment of FIG. 1, the wafer defect detection and classification system 100 illustratively includes a training data generation module 110, and a training and defect detection/classification module 120. In the embodiment of FIG. 1 the training and defect detection/classification module 120 includes a learning model 122 (described in greater detail below). The wafer defect detection and classification system 100 of FIG. 1 further illustratively includes an optional storage device 130.

As depicted in FIG. 1, embodiments of a wafer defect detection and classification system of the present principles, such as the wafer defect detection and classification system 100, can be implemented via a computing device 800 (described in greater detail below) in accordance with the present principles.

In the wafer defect detection and classification system 100 of FIG. 1, the training data generation module 110 can receive data including labeled images of wafer defects, which include at least the defect classification of the imaged defect. In some embodiments, such labeled image data can be received from/retrieved from the optional storage device. Alternatively or in addition, the training data generation module 110 can receive labeled image data from a user of a wafer defect detection and classification system of the present principles such as the wafer defect detection and classification system 100 of FIG. 1. The labeled image data received by the training data generation module 110 can be used to train the learning model 122 (described in greater detail below).

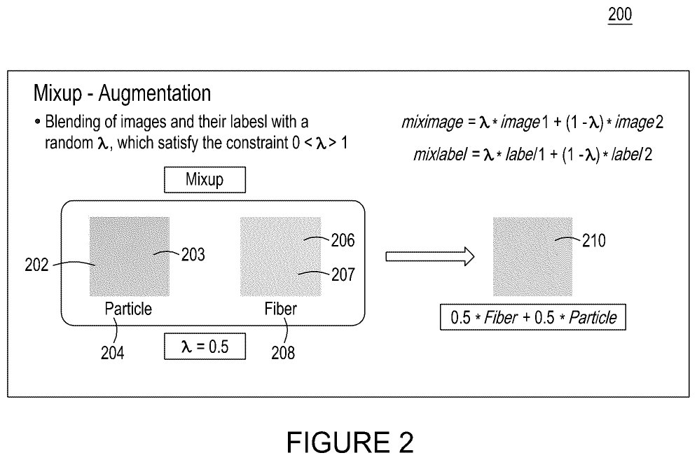

Data for training the learning model 122, however can be limited. As such, due to the lack of training data available for training the learning model 122, the training data generation module 110 of FIG. 1 can implement unique data augmentation techniques to compensate for the limited availability of training data. For example, in some embodiments the training data generation module 110 can implement a mix-up augmentation process to generate additional training data for training the learning model 122. For example, FIG. 2 depicts a graphical representation of a mix-up augmentation process 200 that can be implemented by the training data generation module 110 of FIG. 1 for generating training data for training the learning model 122 in accordance with an embodiment of the present principles.

In accordance with the present principles, a mix-up augmentation process can include the blending of images of wafer defects which include respective labels identifying any defects on the wafer. For example, in the embodiment of FIG. 2, the mix-up augmentation process 200 is depicted as including the blending of an image 202 containing a particle defect 203 having a respective particle defect label 204 with an image 206 of a fiber defect 207 having a respective fiber defect label 208. In the embodiment of the mix-up augmentation process 200 of FIG. 2, the images and the labels can be respectively blended using a weighted component, λ (0.5 in the example of FIG. 2), for example according to equations one (1) and two (2), which follow:

$$miximage = λ * image 1 + ( 1 - λ ) * image 2 \qquad ( 1 )$$

$$mixlabel = λ * label 1 + ( 1 - λ ) * label 2. \qquad ( 2 )$$

The mix-up augmentation process of the present principles functions like a regularization method clarifying a resultant model with each class boundary. That is, a classifier/model generally learns a hard decision boundary to distinguish classes based on the model. In some embodiments of the present principles, a mix-up augmentation process of the present principles considers intermediate images during a learning process which enables a model to learn a diffused boundary. This makes the model more regularized or robust to predict intermediate images with a respective amount of class mixture. For example, in the embodiment of FIG. 2, the resultant blended image 210 can be used as additional data to train a learning model of the present principles to recognize/detect wafer detects and to classify the detected wafer defects into categories in accordance with the present principles.

Although in the embodiment of FIG. 2 the mix-up augmentation process 200 implemented by the training data generation module 110 is depicted as blending two images, an image of a labeled particle defect and an image of a labeled fiber defect, alternatively or in addition, in other embodiments of the present principles, a training data generation module of the present principles can implement a mix-up augmentation process to blend other numbers and types of labeled defect images to generate training data for the learning model 122 in accordance with the present principles.

In some embodiments, the training data received and/or generated by the training data generation module 110 is communicated to the training and defect detection/classification module 120 of a wafer defect detection and classification system of the present principles, such as the wafer defect detection and classification system 100 of FIG. 1. In some embodiments, the training and defect detection/classification module 120 uses the received training data to train the learning model 122 to recognize/detect and distinguish between various types of defects that occur on wafers and to classify the defects into categories. In some embodiments, the defects can be classified into categories including, but not limited to, particle defect, fiber defect, stain defect and/or no defect.

In some embodiments, a model/algorithm of the present principles, such as the learning model/algorithm 122, can include a multi-layer neural network comprising nodes that are trained to have specific weights and biases. In some embodiments, the learning model/algorithm 122 employs artificial intelligence techniques or machine learning techniques to analyze received data images including wafer defects. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data.

The learning model/algorithm 122 can be trained using a plurality (e.g., hundreds, thousands, etc.) of instances of labeled image data in which the training data comprises a plurality of labeled images of wafer defects to train a learning model/algorithm of the present principles to recognize/detect and distinguish between various types of defects on wafers and to classify the defects into categories.

For example, in one training instance a training dataset which included a total of 21,000 labeled images of wafer defects was used to train a learning model/algorithm of the present principles. In the training instance, relevant images in the training dataset were selected in similar ratio to correct any skewness in the training dataset. In the training instance, a mix-up augmentation was applied to new images of the dataset at each iteration, which subjected the learning model/algorithm of the present principles to 21000 variations of the training data.

For example, in some embodiments a transformer, such as a ViT (Vision Transformer), can be used to convert each image into multiple patches and a positional encoding can be applied to each patch. The results can be fed into an encoder with multi head attention. In some embodiments, a varying learning rate can be applied to each layer so that a resulting model can be optimized without disturbing respective pretrained weights.

After the training of a learning model of the present principles, such as the learning model 122 of FIG. 1, the accuracy of the learning model/algorithm of the present principles was validated/tested using 105 images of wafer defects having four (4) different classifications, which included 27 images of stain defects, 33 images of particle defects, 25 images of fiber defects, and 20 images of false count (no defects).

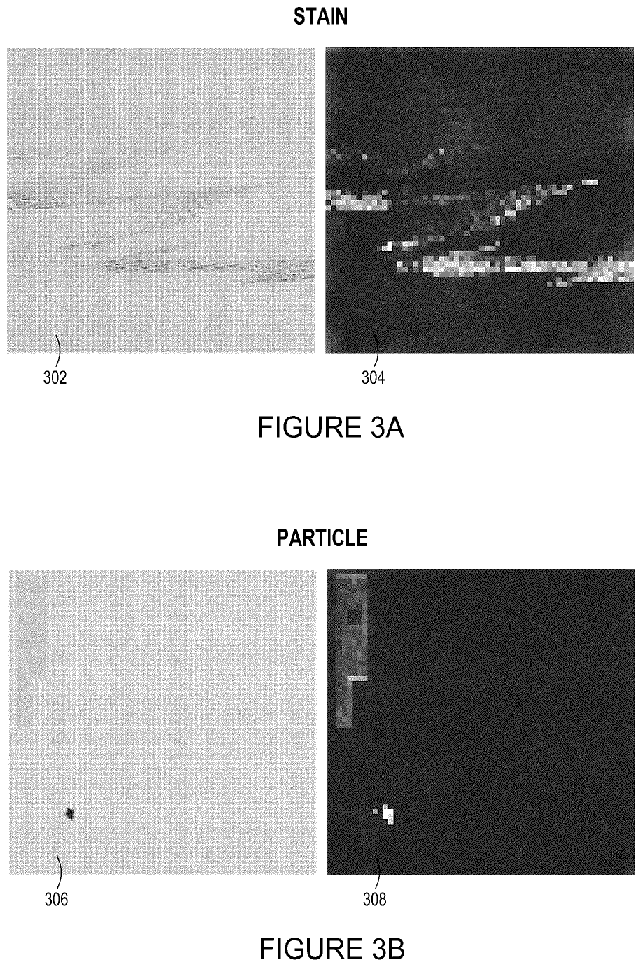

In the validation/testing process described above, a region of interest of the learning model/algorithm of the present principles during testing using the validation images was analyzed using attention maps to confirm whether the learning model/algorithm of the present principles was focusing on a correct area of the validation images, which contained the wafer defect, when detecting and/or classifying the wafer defect in accordance with the present principles. FIGS. 3A-3D depict validation images of a wafer and respective attention maps that depict a focus of the learning model/algorithm of the present principles when considering the validation image.

More specifically, FIG. 3A depicts an image 302 of a stain defect on a wafer and a corresponding attention map image 304 of a region of focus of a machine learning model/algorithm of the present principles when processing the image. As can be seen in FIG. 3A, the learning model/algorithm properly focuses on the region containing the stain defect on the image of the wafer.

FIG. 3B depicts an image 306 of a particle defect on a wafer and a corresponding attention map image 308 of a region of focus of a machine learning model/algorithm of the present principles when processing the image. As can be seen in FIG. 3B, the learning model/algorithm properly focuses on the region containing the particle defect on the image of the wafer.

FIG. 3C depicts an image 310 of a fiber defect on a wafer and a corresponding attention map image 312 of a region of focus of a machine learning model/algorithm of the present principles when processing the image. As can be seen in FIG. 3C, the learning model/algorithm properly focuses on the region containing the fiber defect on the image of the wafer.

FIG. 3D depicts an image 314 of a wafer having no defect and a corresponding attention map image 316 of a region of focus of a machine learning model/algorithm of the present principles when processing the image. In the embodiment of FIG. 3D, the learning model/algorithm focuses on the background of the image of the wafer as the learning model/algorithm is unable to detect any other class of defects in the image of the wafer.

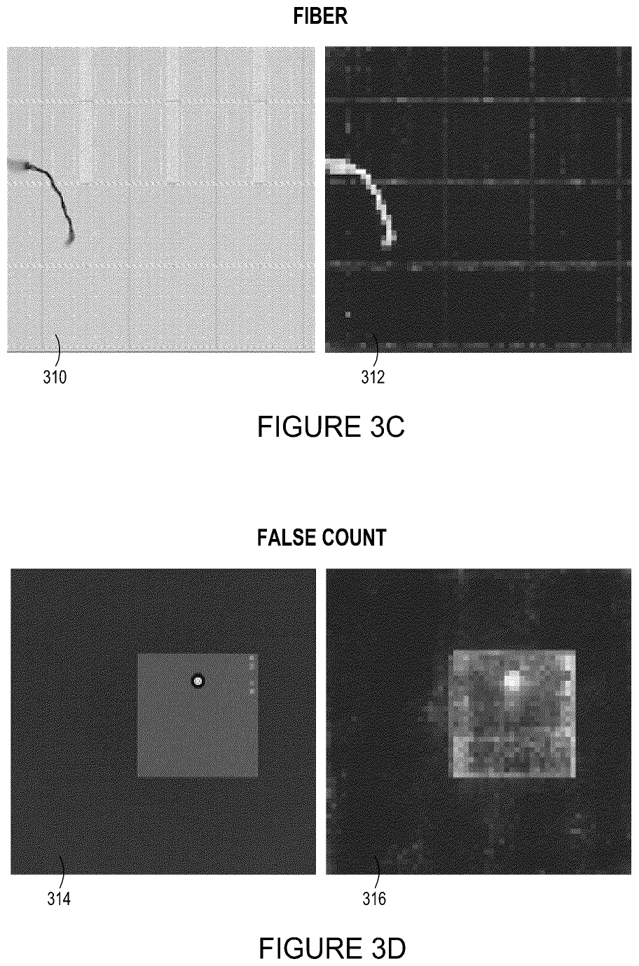

FIG. 4 depicts a graphical representation of a functional training architecture of a wafer defect detection and classification system of the present principles such as the wafer defect detection and classification system 100 of FIG. 1. As depicted in FIG. 4, labeled images (illustratively an SEM image) 402 are received by the wafer defect detection and classification system 100. The received images 402 are supplemented using a mix-up augmentation process 410 as described above and in accordance with the preset principles to produce augmented, labeled images. The received labeled, images 402 and the augmented, labeled images are used to train the learning model of the present principles (illustratively a Vision Transformer (ViT) model) 422 to recognize/detect and distinguish between various types of defects that occur on wafers and to classify the defects into categories from the received, labeled images 402 and the augmented, labeled images.

In the embodiment of FIG. 4, the ViT model 422 implements attention mechanisms to determine on which part of the images to focus (region of interest (ROI)). That is, in the embodiment of FIG. 4, a region of interest (ROI) determined by the ViT model 422 is analyzed using an attention map 415 to confirm whether the ViT model 422 of the present principles was focusing on a correct area of the images. The trained Vit model 422 can then be applied as, for example, a classifier to recognize/detect and distinguish between various types of defects that occur on wafers and to classify the defects into categories from images, such as SEM images. Although in the embodiment of FIG. 4 the learning model of the present principles is depicted as a ViT model, in alternate embodiments of the present principles an ML model of the present principles can alternatively or in addition include neural networks such as a convolutional neural network or a recurrent neural network and the like.

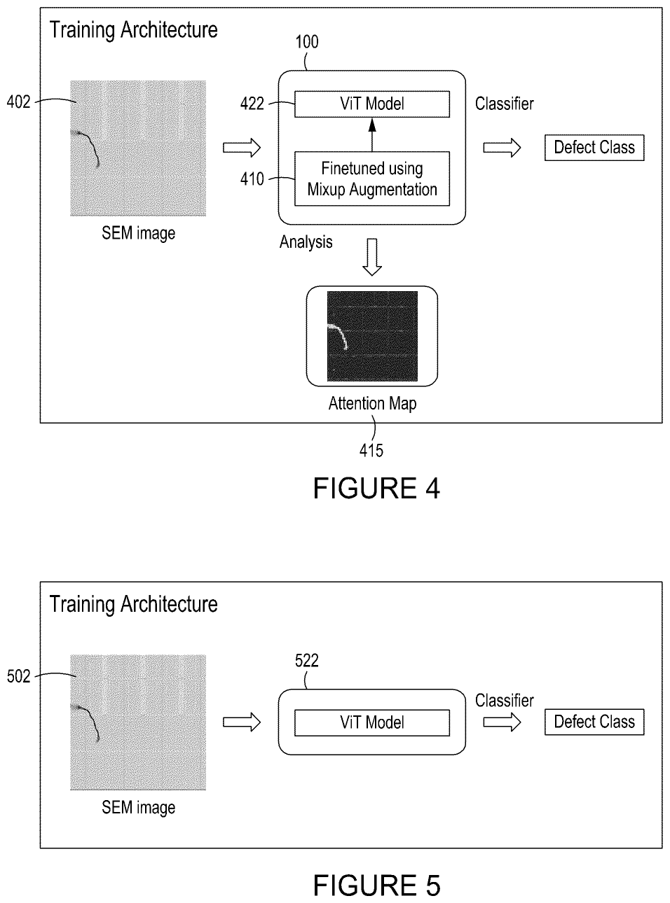

FIG. 5 depicts a graphical representation of a functional architecture of a wafer defect detection and classification system of the present principles, such as the wafer defect detection and classification system 100 of FIG. 1, in accordance with an embodiment of the present principles. As depicted in FIG. 5, at least one SEM image 502 can be received by the wafer defect detection and classification system 100. The ML model (illustratively a ViT model) 522 trained in accordance with the present principles, identifies wafer defects in the at least one SEM image 502 and classifies the defects into defect classes.

The defect classes of the wafer defects determined by an ML classifier of the present principles can be used to determine, for example, a throughput of a wafer system. For example, a defect class of a wafer defect, determined in accordance with the present principles, can be used to determine if a defect(s) on a wafer is critical and if the wafer having the particular defect has to be scrapped or removed from a wafer processing system.

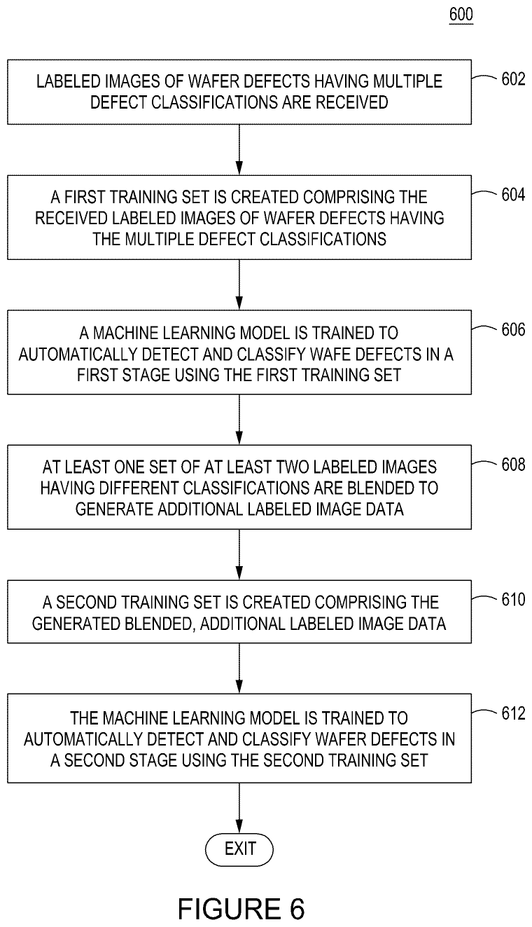

FIG. 6 depicts a flow diagram of a method 600 for training a machine learning model for the automatic detection and classification of defects on wafers in accordance with an embodiment of the present principles. The method can begin at 602 during which labeled images of wafer defects having multiple defect classifications are received. The method 600 can proceed to 604.

At 604, a first training set is created comprising the received labeled images of wafer defects having the multiple defect classifications. The method 600 can proceed to 606.

At 606, the machine learning model is trained to automatically detect and classify wafer defects in a first stage using the first training set. The method 600 can proceed to 608.

At 608, at least one set of at least two labeled images having different classifications are blended to generate additional labeled image data. The method 600 can proceed to 610.

At 610, a second training set is created comprising the generated blended, additional labeled image data. The method 600 can proceed to 612.

At 612, the machine learning model is trained to automatically detect and classify wafer defects in a second stage using the second training set. The method 600 can be exited.

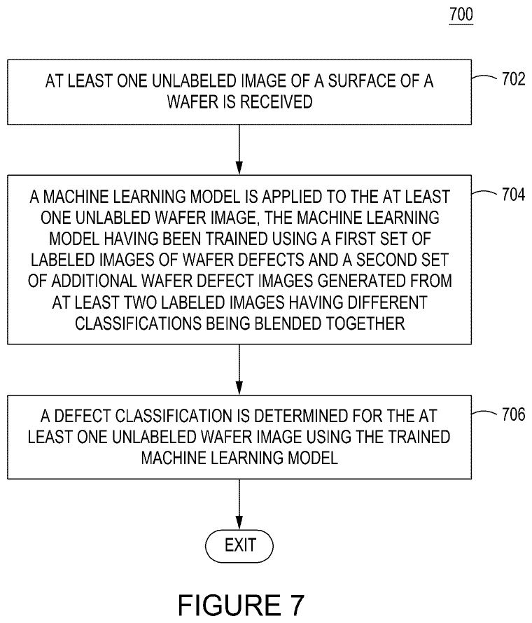

FIG. 7 depicts a flow diagram of a method 700 for the automatic detection and classification of defects on wafers using a trained machine learning model in accordance with an embodiment of the present principles. The method can begin at 702 during which at least one unlabeled image of a surface of a wafer is received. The method 700 can proceed to 704.

At 704, a machine learning model is applied to the at least one unlabeled wafer image, the machine learning model having been trained using a first set of labeled images of wafer defects and a second set of additional wafer defect images generated from at least two labeled images having different classifications being blended together. The method 700 can proceed to 706.

At 706, a defect classification is determined for the at least one unlabeled wafer image using the trained machine learning model. The method 700 can be exited.

As depicted in FIG. 1, embodiments of a wafer defect detection and classification system of the present principles, such as the wafer defect detection and classification system 100 of FIG. 1, can be implemented in a computing device 800 in accordance with the present principles. That is, in some embodiments, wafer defect image data and the like can be communicated to a wafer defect detection and classification system of the present principles using the computing device 800 via, for example, any input/output means associated with the computing device 800. Classification data associated with a wafer defect detection and classification system of the present principles can be presented to a user using an output device of the computing device 800, such as a display, a printer or any other form of output device.

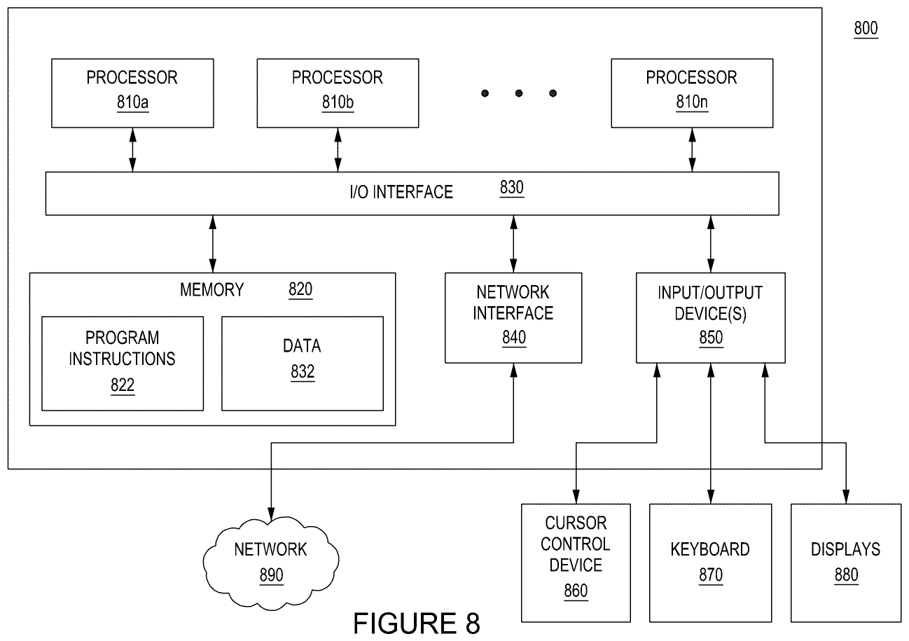

For example, FIG. 8 depicts a high-level block diagram of a computing device 800 suitable for use with embodiments of a wafer defect detection and classification system in accordance with the present principles, such as the wafer defect detection and classification system 100 of FIG. 1. In some embodiments, the computing device 800 can be configured to implement methods of the present principles as processor-executable executable program instructions 822 (e.g., program instructions executable by processor(s) 810) in various embodiments.

In the embodiment of FIG. 8, the computing device 800 includes one or more processors 810a-810n coupled to a system memory 820 via an input/output (I/O) interface 830. The computing device 800 further includes a network interface 840 coupled to I/O interface 830, and one or more input/output devices 850, such as cursor control device 860, keyboard 870, and display(s) 880. In various embodiments, a user interface can be generated and displayed on display 880. In some cases, it is contemplated that embodiments can be implemented using a single instance of computing device 800, while in other embodiments multiple such systems, or multiple nodes making up the computing device 800, can be configured to host different portions or instances of various embodiments. For example, in one embodiment some elements can be implemented via one or more nodes of the computing device 800 that are distinct from those nodes implementing other elements. In another example, multiple nodes may implement the computing device 800 in a distributed manner.

In different embodiments, the computing device 800 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 800 can be a uniprocessor system including one processor 810, or a multiprocessor system including several processors 810 (e.g., two, four, eight, or another suitable number). Processors 810 can be any suitable processor capable of executing instructions. For example, in various embodiments processors 810 may be general-purpose or embedded processors implementing any of a variety of instruction set architectures (ISAs). In multiprocessor systems, each of processors 810 may commonly, but not necessarily, implement the same ISA.

System memory 820 can be configured to store program instructions 822 and/or data 832 accessible by processor 810. In various embodiments, system memory 820 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 820. In other embodiments, program instructions and/or data can be received, sent or stored upon different types of computer-accessible media or on similar media separate from system memory 820 or computing device 800.

In one embodiment, I/O interface 830 can be configured to coordinate I/O traffic between processor 810, system memory 820, and any peripheral devices in the device, including network interface 840 or other peripheral interfaces, such as input/output devices 850. In some embodiments, I/O interface 830 can perform any necessary protocol, timing or other data transformations to convert data signals from one component (e.g., system memory 820) into a format suitable for use by another component (e.g., processor 810). In some embodiments, I/O interface 830 can include support for devices attached through various types of peripheral buses, such as a variant of the Peripheral Component Interconnect (PCI) bus standard or the Universal Serial Bus (USB) standard, for example. In some embodiments, the function of I/O interface 830 can be split into two or more separate components, such as a north bridge and a south bridge, for example. Also, in some embodiments some or all of the functionality of I/O interface 830, such as an interface to system memory 820, can be incorporated directly into processor 810.

Network interface 840 can be configured to allow data to be exchanged between the computing device 800 and other devices attached to a network (e.g., network 890), such as one or more external systems or between nodes of the computing device 800. In various embodiments, network 890 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 840 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 850 can, in some embodiments, include one or more display terminals, keyboards, keypads, touchpads, scanning devices, voice or optical recognition devices, or any other devices suitable for entering or accessing data by one or more computer systems. Multiple input/output devices 850 can be present in computer system or can be distributed on various nodes of the computing device 800. In some embodiments, similar input/output devices can be separate from the computing device 800 and can interact with one or more nodes of the computing device 800 through a wired or wireless connection, such as over network interface 840.

Those skilled in the art will appreciate that the computing device 800 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 800 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 800 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 800 can further include a web browser.

Although the computing device 800 is depicted as a general-purpose computer, the computing device 800 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

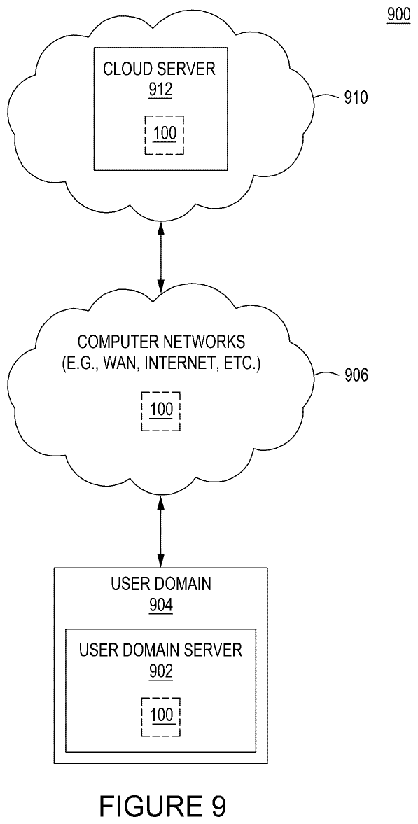

FIG. 9 depicts a high-level block diagram of a network in which embodiments of a wafer defect detection and classification system of the present principles in accordance with the present principles, such as the wafer defect detection and classification system 100 of FIG. 1, can be applied. The network environment 900 of FIG. 9 illustratively comprises a user domain 902 including a user domain server/computing device 904. The network environment 900 of FIG. 9 further comprises computer networks 906, and an on premise (e.g., cloud) environment 910 including an on premise server/computing device 912.

In the network environment 900 of FIG. 9, a wafer defect detection and classification system in accordance with the present principles, such as the wafer defect detection and classification system of FIG. 1, can be included in at least one of the user domain server/computing device 904, the computer networks 906, and the on premise server/computing device 912. That is, in some embodiments, a user can use a local server/computing device (e.g., the user domain server/computing device 904) to detect and classify wafer defects in accordance with the present principles.

In some embodiments, a user can implement a system for detecting and classifying wafer defects in the computer networks 906 in accordance with the present principles. Alternatively or in addition, in some embodiments, a user can implement a system for detecting and classifying wafer defects in the on premise server/computing device 912 of the on premise environment 910 to provide container forensics in accordance with the present principles. For example, in some embodiments it can be advantageous to perform processing functions of the present principles in the on premise environment 910 to take advantage of the processing capabilities and storage capabilities of the on premise environment 910. In some embodiments in accordance with the present principles, a system for detecting and classifying wafer defects can be located in a single and/or multiple locations/servers/computers to perform all or portions of the herein described functionalities of a system in accordance with the present principles. For example, a wafer defect detection and classification system of the present principles can be located in one or more than one of the user domain 902, the computer network environment 906, and the on premise environment 910 for detecting and classifying wafer defects in accordance with the present principles.

Those skilled in the art will appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 600 can be transmitted to the computing device 600 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present disclosure, other and further embodiments of the disclosure may be devised without departing from the basic scope thereof.

1. A method for training a machine learning model for the automatic detection and classification of defects on wafers, comprising:
receiving labeled images of wafer defects having multiple defect classifications;
creating a first training set comprising the received labeled images of wafer defects having the multiple defect classifications;
training the machine learning model to automatically detect and classify wafer defects in a first stage using the first training set;
blending at least one set of at least two labeled images having different classifications to generate additional labeled image data;
creating a second training set comprising the generated blended, additional labeled image data; and
training the machine learning model to automatically detect and classify wafer defects in a second stage using the second training set.

2. The method of claim 1, wherein the multiple defect classifications comprise at least two of a particle defect, a fiber defect, a stain defect, or no defect.

3. The method of claim 1, wherein the ML model comprises at least one of a vision transformer model, a convolutional neural network model, or a recurrent neural network model.

4. The method of claim 1, further comprising:
blending the at least one set of the at least two labeled images having different classifications using at least one weighted component.

5. The method of claim 1, wherein the at least one set of the at least two labeled images having different classifications are blended using a mix-up augmentation process.

6. A method for the automatic detection and classification of defects on wafers using a trained machine learning model, comprising:
receiving at least one unlabeled image of a surface of a wafer;
applying the trained machine learning (ML) model to the at least one unlabeled wafer image, the machine learning model having been trained to detect and classify defects on wafers using a first set of labeled images of wafer defects and a second set of additional wafer defect images generated from at least two labeled images having different classifications being blended; and
determining at least one defect classification for the at least one unlabeled wafer image using the trained machine learning model.

7. The method of claim 6, wherein the at least one defect classification comprises at least one of a particle defect, a fiber defect, a stain defect, or no defect.

8. The method of claim 6, further comprising:
determining if the wafer contains a critical defect from the at least one determined defect classification.

9. The method of claim 6, wherein the trained ML model comprises at least one of a vision transformer model, a convolutional neural network model, or a recurrent neural network model.

10. The method of claim 6, wherein the second set of additional wafer defect images are generated using at least one weighted component.

11. An apparatus for training a machine learning model for the automatic detection and classification of defects on wafers, comprising:
a processor; and
a memory having stored therein at least one program, the at least one program including instructions which, when executed by the processor, cause the apparatus to perform a method, comprising;
receiving labeled images of wafer defects having multiple defect classifications;
creating a first training set comprising the received labeled images of wafer defects having the multiple defect classifications;
training the machine learning model to automatically detect and classify wafer defects in a first stage using the first training set;
blending at least one set of at least two labeled images having different classifications to generate additional labeled image data;
creating a second training set comprising the generated blended, additional labeled image data; and
training the machine learning model to automatically detect and classify wafer defects in a second stage using the second training set.

12. The apparatus of claim 11, wherein the multiple defect classifications comprise at least two of a particle defect, a fiber defect, a stain defect, or no defect.

13. The apparatus of claim 11, wherein the ML model comprises at least one of a vision transformer model, a convolutional neural network model, or a recurrent neural network model.

14. The apparatus of claim 11, wherein the method further comprises:
blending the at least one set of the at least two labeled images having different classifications using at least one weighted component.

15. The apparatus of claim 11, wherein the at least one set of the at least two labeled images having different classifications are blended using a mix-up augmentation process.

16. An apparatus for the automatic detection and classification of defects on wafers using a trained machine learning model, comprising:
a processor; and
a memory having stored therein at least one program, the at least one program including instructions which, when executed by the processor, cause the apparatus to perform a method, comprising;
receiving at least one unlabeled image of a surface of a wafer;
applying the trained machine learning (ML) model to the at least one unlabeled wafer image, the machine learning model having been trained to detect and classify defects on wafers using a first set of labeled images of wafer defects and a second set of additional wafer defect images generated from at least two labeled images having different classifications being blended; and
determining at least one defect classification for the at least one unlabeled wafer image using the trained machine learning model.

17. The apparatus of claim 16, wherein the at least one defect classification comprises at least one of a particle defect, a fiber defect, a stain defect, or no defect.

18. The apparatus of claim 16, wherein the method further comprises:
determining if the wafer contains a critical defect from the at least one determined defect classification.

19. The apparatus of claim 16, wherein the trained ML model comprises at least one of a vision transformer model, a convolutional neural network model, or a recurrent neural network model.

20. The apparatus of claim 16, wherein the second set of additional wafer defect images are generated using at least one weighted component.
